(19) United States
(12) Patent Application Publication
(10) Pub. No.: US 2025/0304086 A1
(43) Pub. Date: Oct. 2, 2025

(54) SOFTWARE UPDATE MANAGEMENT DEVICE AND SOFTWARE UPDATE MANAGEMENT METHOD

(71) Applicant: HONDA MOTOR CO., LTD., Tokyo (JP)

(72) Inventors: Takashi Tsujioka, Tokyo (JP); Tomoya Kitano, Tokyo (JP); Takayoshi Nakamura, Tokyo (JP)

(21) Appl. No.: 19/011,015

(22) Filed: Jan. 6, 2025

(30) Foreign Application Priority Data
Mar. 26, 2024 (JP) 2024-048937

(51) Int. Cl. B60W 50/12; G06F 8/65

(52) U.S. Cl. CPC B60W 50/12; G06F 8/65

(57) ABSTRACT

A software update management device that includes: a function of updating software of a vehicle control unit loaded on a vehicle, which is targeted at the vehicle that includes a travel motor as a driving source and a battery, and makes transition between states including a first state where the travel motor is inoperable and a second state where the travel motor is operable. When the vehicle is in a stopped state or the first state and the battery is being charged, the vehicle is prohibited to make transition to the second state and the software of the vehicle control unit is updated.

### INCORPORATION BY REFERENCE

The present application claims priority under 35 U.S.C. § 119 to Japanese Patent Application No. 2024-048937 filed on Mar. 26, 2024. The content of the application is incorporated herein by reference in its entirety.

### BACKGROUND OF THE INVENTION

### Field of the Invention

The present invention relates to a software update management device and a software update management method.

### Description of the Related Art

In recent years, researches and developments on traffic safety, which are beneficial for efficient energy use, have been conducted for allowing more people to have access to reasonable, reliable, sustainable, and advanced energy. For example, Japanese Patent Laid-Open No. 2006-082648 discloses a technique for enabling rewriting of programs while ensuring security of vehicles. When the system disclosed in Japanese Patent Laid-Open No. 2006-082648 attempts to rewrite a program on a security-related ECU that controls the security functions of the vehicle and if the user is not nearby the vehicle, the system brings the program rewriting to a halt.

The technique disclosed in Japanese Patent Laid-Open No. 2006-082648 does not allow program rewriting unless the user is nearby the vehicle. The problem with this is that it is difficult to secure the opportunities to update the software.

In order to overcome the problem, it is an object of the present application to enable update of the software related to vehicle monitoring while ensuring security of the vehicle, and improve the safety. This consequently improves the traffic safety still further and contributes to development of sustainable transportation systems.

### SUMMARY OF THE INVENTION

A first aspect of the present disclosure is a software update management device that includes: a function of updating software of a vehicle control unit loaded on a vehicle, the function being targeted at the vehicle that includes a travel motor as a driving source and a battery, the vehicle being configured to make transition between states including a first state where the travel motor is inoperable and a second state where the travel motor is operable, in which, when the vehicle is in the first state and the battery is being charged, the vehicle is prohibited to make transition to the second state and the software of the vehicle control unit is updated.

Another aspect of the present disclosure is a software update management method causing a computer to manage software of a vehicle that includes a travel motor as a driving source and a battery, the vehicle being configured to make transition between states including a first state where the travel motor is inoperable and a second state where the travel motor is operable, the software update management method including: when the vehicle is in the first state and the battery is being charged, updating software of a vehicle control unit loaded on the vehicle while prohibiting transition of the vehicle to the second state.

According to one aspect of the present disclosure, the state where the vehicle is not able to travel can be ensured during the update of the software. This makes it possible to update the software while ensuring the security of the vehicle and improve the safety still further.

### BRIEF DESCRIPTION OF THE DRAWINGS

FIG. 1 is a diagram showing a configuration example of a software update system;

FIG. 2 is a diagram showing a configuration of a vehicle; and

FIG. 3 is a flowchart showing an operation example of a management ECU.

### DETAILED DESCRIPTION OF THE INVENTION

Hereinafter, embodiments of the present invention will be described with reference to the accompanying drawings.

### 1. Configuration of Software Update System

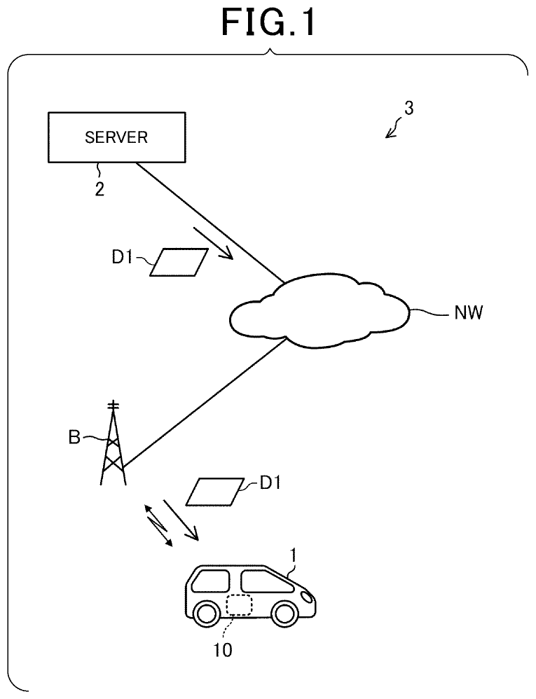

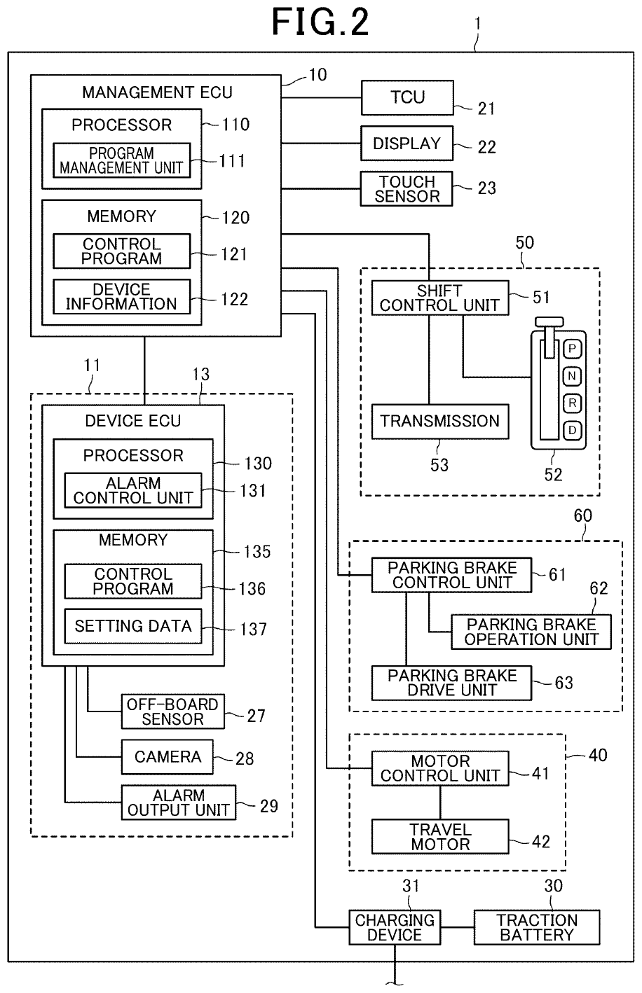

FIG. 1 is a diagram showing a configuration example of a software update system 3 related to update of software of a vehicle 1. The software update system 3 includes a server 2 that provides software to be executed by a device ECU 13 (FIG. 2) loaded on the vehicle 1, and the server 2 is connected to the vehicle 1 to be communicable via a communication network NW. The vehicle 1 downloads software from the server 2, and updates the software included in the device ECU 13. In other words, the software update system 3 enables update of the software in the vehicle 1 by OTA (On The Air).

The vehicle 1 may be a four-wheel vehicle, a two-wheel vehicle, and any other vehicle, and may also be a large vehicle, a commercial vehicle, a work vehicle, or the like. As an example, it is assumed to be a four-wheel vehicle in the present embodiment.

In the following description, software includes a program executed by a processor as well as data that is referred to, generated, updated, and deleted in association with the program, and includes firmware. Update of software means processing for replacing the software executed by the processor with the latest version of software, and specific forms thereof may be any of adding, deleting, and overwriting software. Furthermore, processing for deleting part of or entire software executed by the processor, installing new software, and deleting, adding, and overwriting the data used when executing the software may also be included in update of software.

The server 2 is a computer that is connected to the communication network NW via a wired communication line or a wireless communication line, and connected to the vehicle 1 to be communicable.

The vehicle 1 is connected to the communication network NW by wireless communication via a cellular communication base station B, for example. There is no limit set for the specific form of the communication network NW. For example, the communication network NW may include a cellular communication network, the Internet, WAN (Wide Area Network), LAN (Local Area Network), a public network, a provider device, a dedicated line, a base station, and the like.

Data used for updating the software of the vehicle 1 is referred to as update data D1. The update data D1 includes at least a program or data. For example, it includes a new version of program, data to be added, data designating the program or data to be deleted, data regarding the device as the update target, and the like. Furthermore, processing for distributing the update data D1 to the vehicle 1 is referred to as distribution processing. Update of the software of the vehicle 1 includes the distribution processing and update processing for updating the software of the vehicle 1 based on the update data D1 that is distributed to the vehicle 1 by the distribution processing.

### 2. Configuration of Vehicle

The vehicle 1 includes a plurality of devices that implement the functions of the vehicle 1, and includes a vehicle control unit that controls those devices. As the devices provided to the vehicle 1, a monitoring device 11, a traction battery 30, a motor drive unit 40, a shift device 50, and a parking brake device 60 are shown in FIG. 2. The vehicle 1 may also include an internal combustion engine functioning as a driving source of the vehicle 1, and a device for locking and unlocking the door locks of the vehicle 1. Furthermore, the vehicle 1 may include ICB (Infotainment Control Box), MPU (Map Positioning Unit), MVC (Multi View Camera), PKS (Parking Support System), and ADAS (Advanced Driver Assistance System). The vehicle 1 may also include operation devices such as an accelerator pedal and a brake pedal as well as a VSA (Vehicle Stability Assist) device, and the like.

The vehicle 1 may be any of an electric vehicle that includes a motor running on electric power as the driving source and a vehicle having an internal combustion engine loaded thereon. The internal combustion engine may function as a power source for driving the vehicle 1, and may also be a power generation device that drives a generator. The vehicle 1 according to the present embodiment includes at least the traction battery 30 and a travel motor 42 that runs on the electric power of the traction battery 30. The vehicle 1 travels using the travel motor 42 as the driving source.

In the present embodiment, the operation state of the vehicle 1 can transition among three kinds of states including an ignition-on (IG ON) state, an ignition-off (IG OFF) state, and a stopped state. The ignition-on state is a state where the travel motor 42 that is the driving source of the vehicle 1 is running. The state where the travel motor 42 is running is not limited to a state where the travel motor 42 is rotating. It also includes a state where the electric power can be supplied to the travel motor 42 from an inverter circuit or the like, which is a state where the travel motor 42 can be promptly rotated in response to an operation of the driver such as an operation of the accelerator, and the like. For example, the ignition-on state can also be expressed as a state where the inverter circuit is working. In the ignition-on state, a state where the travel motor 42 is not rotating is referred to as an ignition-ready (IG Ready). The ignition-ready state is equivalent to the ignition-on state except that the travel motor 42 is not actually rotating, so that it can be considered as the same state as the ignition-on state. When the vehicle 1 has the internal combustion engine loaded thereon, the ignition-on state includes a state where the internal combustion engine is rotating and a state where the internal combustion engine can be promptly started. The ignition-off state is a state where the travel motor 42 is inoperable, and it is an example of a first state according to the present disclosure. The ignition-on state and the ignition-ready state are states where the travel motor 42 is operable, and those are examples of a second state according to the present disclosure.

The ignition-off state is a state where the travel motor 42 as the driving source of the vehicle 1 and the internal combustion engine are not operating, electric power is supplied at least to some of the control devices of the vehicle 1 including the device ECU 13, and the control devices are in an operable state. The stopped state is a state where electric power is supplied to the minimum control devices required for placing the vehicle 1 to the ignition-off state, and supply of electric power is stopped for the other control devices and the driving source of the vehicle 1. The monitoring device 11 operates at least in the stopped state, and may also operate in the ignition-off state.

The monitoring device 11 includes the device ECU 13 that functions as the vehicle control unit. The device ECU (Electronic Control Unit) 13 controls the monitoring device 11 by executing the program. The monitoring device 11 is an example of monitoring equipment.

The device ECU 13 includes a processor 130 and a memory 135. The memory 135 is a nonvolatile storage device configured with a magnetic recording medium or a semiconductor memory element, and stores a control program 136 that is executed by the processor 130 and data that is referred to, generated, or processed when the control program 136 is executed. For example, the memory 135 stores setting data 137. The device ECU 13 is an example of the vehicle control unit.

The processor 130 functions as an alarm control unit 131 by executing the control program 136. The alarm control unit 131 starts a detection operation using at least one of an off-board sensor 27 and a camera 28, having the fact that the vehicle 1 is shifted to the stopped state as the trigger. During the execution of the detection operation, the alarm control unit 131 analyzes the detection result of the off-board sensor 27 and captured images captured by the camera 28. The alarm control unit 131 collates the analysis result with the setting data 137 to detect suspicious behaviors toward the vehicle 1, vibration of the vehicle 1, and the like. When a suspicious behavior toward the vehicle 1 or vibration of the vehicle 1 is detected, the alarm control unit 131 issues a notification by an alarm output unit 29 and saves the captured images of the camera 28 in the memory 135.

The vehicle 1 includes a management ECU 10. The management ECU 10 manages update of the software of the vehicle control unit provided in the vehicle 1. In the example illustrated in FIG. 2, the management ECU 10 has the device ECU 13 as the target, and manages update of the program executed by the device ECU 13 and the data that is processed during execution of the program. The management ECU 10 is an example of a software update management device.

A TCU (Telematics Control Unit) 21, a display 22, and a touch sensor 23 are connected to the management ECU 10. GNSS (Global Navigation Satellite System) for measuring the position of the vehicle 1 may also be connected to the management ECU 10.

The TCU 21 is a communication device that complies with the communication standard of a mobile communication system, and communicates with devices other than the vehicle 1. The TCU 21 includes an antenna, a transmitter, and a receiver, for example, and performs communication under the control of the management ECU 10.

The display 22 includes a liquid crystal display panel or an organic EL (Electro Luminescence) panel, and displays characters and images. The display 22 is installed on a dashboard of the vehicle 1, for example. The touch sensor 23 is placed by being superimposed on a display screen of the display 22, and detects touch operations of the driver or passengers in the vehicle 1.

The management ECU 10 includes a processor 110 and a memory 120. The memory 120 is a nonvolatile storage device configured with a magnetic recording medium or a semiconductor memory element, and stores a control program 121 that is executed by the processor 110. Furthermore, the memory 120 stores device information 122 and alternative device information 123. The device information 122 includes information regarding the devices provided in the vehicle 1 and the vehicle control units that control those devices. The device information 122 includes, for each of the vehicle control units, for example, version, last updated data, size, and the like of the programs and data related to the operations of the respective vehicle control unit.

The processor 110 functions as a program management unit 111 by executing the control program 121. The program management unit 111 manages update of the program executed by the device ECU 13 and the data that is processed by the device ECU 13. The program management unit 111 makes an inquiry to the server 2 whether it is necessary to update the software of the device ECU 13 based on the device information 122. When newer version of the control program 136 and/or the setting data 137 than the control program 136 and the setting data 137 installed in the device ECU 13 can be supplied by the server 2, the program management unit 111 determines that it is necessary to update the software of the device ECU 13. In this case, the program management unit 111 downloads the update data DI for updating the control program 136 and/or the setting data 137 from the server 2. The program management unit 111 updates the control program 136 and/or the setting data 137 by using the downloaded update data D1.

The traction battery 30 is a secondary battery that supplies electric power to the travel motor 42. A charging device 31 is connected to the traction battery 30. The charging device 31 charges the traction battery 30 by the electric power supplied to the vehicle 1 from outside.

The motor drive unit 40 includes the travel motor 42 that drives the vehicle 1, and a motor control unit 41 that controls the travel motor 42. A drive circuit, not shown, for supplying the driving current to the travel motor 42 by using the electric power of the traction battery 30 is connected to the travel motor 42. The motor control unit 41 is an ECU having a processor, for example, and rotates the travel motor 42 by controlling the drive circuit of the travel motor 42 according to the operations of the accelerator pedal, switch, or the like, not shown.

The shift device 50 includes a shift control unit 51, a shift operation unit 52, and a transmission 53. The transmission 53 includes power transmission mechanisms such as a speed reducer, a clutch, a torque converter, and the like, which enables the vehicle 1 to travel by the driving force of the travel motor 42 and switches the traveling state of the vehicle 1 by the control of the shift control unit 51. The traveling state of the vehicle 1 includes moving forward, moving backward, and stopping, and the transmission 53 has shift ranges corresponding to the traveling state of the vehicle 1. The transmission 53 according to the present embodiment is capable of switching the ranges among “D” range where the vehicle 1 moves forward, “R” range where the vehicle 1 moves backward, “P” range where the vehicle 1 is kept in a stopped state, and “N” range where the driving source of the vehicle 1 is disconnected from the wheels of the vehicle 1. The “D” range and the “R” range of the transmission 53 are examples of the traveling state of the present disclosure, and the “P” range is an example of a parking state.

The shift control unit 51 is an ECU having a processor, for example, and controls the transmission 53 according to the operation of the shift operation unit 52 to switch the shift ranges of the transmission 53. The shift operation unit 52 is an operation unit that is provided inside the vehicle 1 and operated by the driver of the vehicle 1. The shift operation unit 52 has shift positions for designating the “D” range, the “R” range, the “P” range, and the “N” range of the transmission 53, for example. The shift control unit 51 switches the shift ranges of the transmission 53 in accordance with the shift positions designated by the shift operation unit 52.

The parking brake device 60 is a brake device that holds the vehicle 1 such that the vehicle 1 does not move because of the external force when the vehicle 1 is being parked. The brake device 60 includes a parking brake control unit 61, a parking brake operation unit 62, and a parking brake drive unit 63. The parking brake drive unit 63 is a brake mechanism that brakes rotation of the wheels of the vehicle 1 or the drive shaft that drives the wheels of the vehicle 1, for example.

The parking brake operation unit 62 is an operation unit that is provided inside the vehicle 1 and operated by the driver of the vehicle 1. The parking brake operation unit 62 includes a switch for switching on and off of the braking by the parking brake drive unit 63, for example. The parking brake control unit 61 is an ECU having a processor, for example, and switches on and off for braking the rotation driven by the parking brake drive unit 63, according to the operation of the parking brake operation unit 62. A state where the parking brake drive unit 63 is on can also be referred to as a state where the parking brake device 60 is in a braking state.

The program management unit 111 performs processing for updating the software of the device ECU 13 by using the update data D1. Since the functions of the monitoring device 11 is inexecutable during the update of the software of the device ECU 13, it is necessary to ensure the security of the vehicle 1. Thus, the program management unit 111 executes update of the software of the device ECU 13 while making sure that it is in a state where the vehicle 1 is not able to travel. Specifically, the program management unit 111 updates the software of the device ECU 13 during charging of the traction battery 30. In general, vehicles rely on the electric power of the battery for traveling are configured in specifications to be restricted from driving the motor during the charging of the battery and from entering the ignition-on state and ignition-ready state. In order to more firmly ensure that the vehicle 1 is not able to travel, the program management unit 111 prohibits the vehicle 1 from entering the ignition-on state and ignition-ready state during the update of the software of the device ECU 13. Furthermore, the program management unit 111 restricts the processing of prohibiting release of the parking brake device 60 and the shift device 50 from switching to the other shift ranges from the “P” range, during the update of the software of the device ECU 13. This makes it possible to greatly reduce the risk of the vehicle 1 being taken away and to maintain the security, since the vehicle 1 is not allowed to travel during the update of the software of the device ECU 13.

### 3. Operations of Management ECU

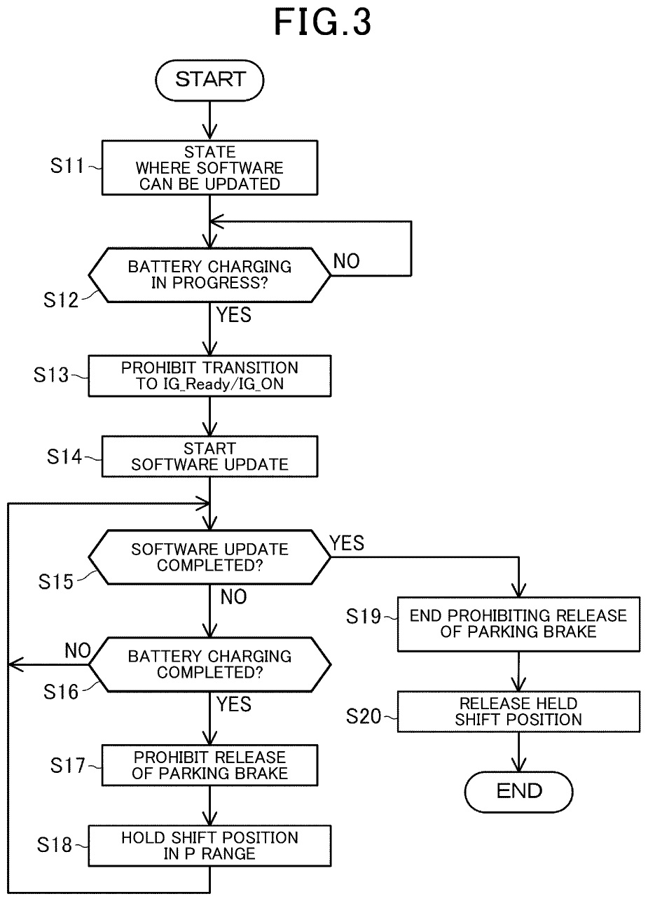

FIG. 3 is a flowchart showing an operation example of the management ECU 10. The operation indicated in FIG. 3 corresponds to an example of the software update management method. Steps S1 to S18 indicated in FIG. 3 are executed by the program management unit 111.

Upon checking, by communicating with the server 2, that it is in a state capable of updating software of the device ECU 13 (step S11), the management ECU 10 starts the operation indicated in FIG. 3. In step S11, the management ECU 10 checks whether the software of the device ECU 13 of the vehicle 1 is subject to update, based on the device information 122, for example.

The management ECU 10 detects the operation state of the charging device 31 to determine whether the traction battery 30 is being charged (step S12). When the traction battery 30 is not being charged (NO in step S12), the management ECU 10 repeats the processing of step S12 at prescribed intervals. In the meantime, the management ECU 10 may execute the operation of downloading the update data D1.

When the traction battery 30 is being charged (YES in step S12), the management ECU 10 prohibits the vehicle 1 from entering the ignition-ready state and entering the ignition-on state (step S13). The management ECU 10 notifies, for example, the ECU, not shown, which controls the operation state of the vehicle 1, that the vehicle 1 is prohibited to enter the ignition-ready state and enter the ignition-on state. Thereafter, the management ECU 10 starts update of the software of the device ECU 13 (step S14).

The management ECU 10 determines whether update of the software of the device ECU 13 is completed (step S15) and, when update is not completed (step S16), determines whether charging of the traction battery 30 is completed (step S17). When charging of the traction battery 30 is not completed (NO in step S17), the management ECU 10 returns to step S15.

When charging of the traction battery 30 is completed (YES in step S17), the management ECU 10 prohibits release of the parking brake device 60 by outputting control data to the parking brake control unit 61 (step S17). While charging the vehicle 1, braking of the parking brake device 60 is on such that the vehicle 1 does not move. When the management ECU 10 prohibits the parking brake device 60 from being set off, the parking brake drive unit 63 maintains the on-state and continues braking of the vehicle 1 even if an operation for setting off the parking brake drive unit 63 is performed by the parking brake operation unit 62.

Subsequently, the management ECU 10 prohibits the shift range of the shift device 50 from being changed to the positions other than the “P” range so as to hold the shift device 50 in the “P” range (step S18), and returns to step S15. Thereby, the transmission 53 maintains the “P” range, and the traveling state of the vehicle 1 is kept in the stopped state.

Meanwhile, when update of the software of the device ECU 13 is completed (YES in step S17), the management ECU 10 ends the state where release of the parking brake device 60 is prohibited (step S19). In a case where release of the parking brake device 60 is not prohibited, the management ECU 10 skips step S19.

Then, the management ECU 10 releases the state where the shift device 50 of the shift device 50 is held in the “P” range (step S20). In a case where the operation for holding the shift device 50 in the “P” range is not executed, the management ECU 10 skips step S20.

The operation of steps S19 to S20 enables the vehicle 1 to travel in accordance with the operation of the driver, after update of the software of the device ECU 13 is completed.

### 4. Other Embodiments

Note that the embodiment described above is only one mode of the present invention, and any modifications and applications thereof are possible without departing from the scope of the present invention.

The configuration of the vehicle 1 shown in FIG. 2 is an example only, and the vehicle 1 may also be in a configuration not shown in FIG. 2. Furthermore, it is also possible to apply the present disclosure to the vehicle 1 that does not include some of the devices illustrated in FIG. 2.

While the configuration in which the management ECU 10 that includes the program management unit 111 is provided separately from the ECU that controls the monitoring device 11 is described in the embodiment above, it is only an example. Specific arrangement of the functional units corresponding to the management ECU 10 can be changed as appropriate. For example, any of the ECUs provided in the vehicle 1 may have the functions of the program management unit 111 of the management ECU 10. Furthermore, the management ECU 10 may be a configuration that has the same functions as those of the ECUs.

Note that FIG. 2 is a schematic diagram which, in order to facilitate the understanding of the invention of the present application, shows the configuration of the vehicle 1 in blocks. However, the application target of the present disclosure is not limited to the configuration illustrated therein. Furthermore, the processing of each of the structural elements may be executed by a single hardware unit or may be executed by a plurality of hardware units. Moreover, the processing shown in FIG. 3 may be executed by a single program or may be executed by a plurality of programs.

### 5. Configurations Supported by the Embodiments

The above-described embodiments support the following Configurations.

(Configuration 1) A software update management device including: a function of updating software of a vehicle control unit loaded on a vehicle, the function being targeted at the vehicle that includes a travel motor as a driving source and a battery, the vehicle being configured to make transition between states including a first state where the travel motor is inoperable and a second state where the travel motor is operable, in which, when the vehicle is in the first state and the battery is being charged, the vehicle is prohibited to make transition to the second state and the software of the vehicle control unit is updated.

According to the software update management device of configuration 1, the state where the vehicle is not able to travel can be ensured during update of the software. This makes it possible to update the software while ensuring the security of the vehicle and to improve the safety still further.

(Configuration 2) The software update management device according to configuration 1, in which the vehicle control unit is a device configured to control monitoring equipment that is configured to monitor the vehicle, and a function of the monitoring equipment is stopped during update of the software of the vehicle control unit.

According to the software update management device of configuration 2, the state where the vehicle is not able to travel can be ensured during update of the software of the monitoring equipment of the vehicle. This makes it possible to ensure the security of the vehicle.

(Configuration 3) The software update management device according to configuration 1 or 2, in which the vehicle is allowed to make transition to the second state, after update of the software of the vehicle control unit is completed.

According to the software update management device of configuration 3, it is possible to return to the state where the vehicle is able to travel after update of the software is completed. Therefore, convenience of the vehicle is improved.

(Configuration 4) The software update management device according to any one of configurations 1 to 3, in which, when charging of the battery is completed during update of the software of the vehicle control unit, the vehicle is prohibited to make transition to the second state until the update of the software of the vehicle control unit is completed.

According to the software update management device of configuration 4, the state where the vehicle is not able to travel can be maintained even when charging of the battery is completed during the update of the software of the vehicle control unit. Therefore, it is possible to ensure the security of the vehicle.

(Configuration 5) The software update management device according to any one of configurations 1 to 4, in which the vehicle includes a shift device configured to switch a traveling state, the shift device is capable of switching among a plurality of shift positions including a parking state where the vehicle is stopped and the traveling state where the vehicle is allowed to travel, when the vehicle is in the first state, the battery is being charged, and the shift device is in the parking state, update of the software of the vehicle control unit is started, and the shift device is prohibited to move from the parking state, until the update of the software of the vehicle control unit is completed.

According to the software update management device of configuration 5, the state where the vehicle is not able to travel can be maintained by setting the shift device in the parking state during the update of the software of the vehicle control unit. This makes it possible to ensure the security of the vehicle.

(Configuration 6) The software update management device according to any one of configurations 1 to 5, in which the vehicle includes a parking brake device, when the vehicle is in the first state, the battery is being charged, and the parking brake device is in a braking state, update of the software of the vehicle control unit is started, and release of the braking state of the parking brake device is prohibited, until the update of the software of the vehicle control unit is completed.

According to the software update management device of configuration 6, the state where the vehicle is not able to travel can be maintained by setting the parking brake device in the braking state during the update of the software of the vehicle control unit. This makes it possible to ensure the security of the vehicle.

(Configuration 7) A software update management method causing a computer to manage software of a vehicle that includes a travel motor as a driving source and a battery, the vehicle being configured to make transition between states including a first state where the travel motor is inoperable and a second state where the travel motor is operable, the software update management method including: when the vehicle is in the first state and the battery is being charged, updating software of a vehicle control unit loaded on the vehicle while prohibiting transition of the vehicle to the second state.

According to the software update management method of configuration 7, the state where the vehicle is not able to travel can be ensured during update of the software. This makes it possible to update the software while ensuring the security of the vehicle and to improve the safety still further.

### REFERENCE SIGNS LIST

1 Vehicle
2 Server
3 Software update system
10 Management ECU
11 Monitoring device (monitoring equipment)
13 Device ECU (vehicle control unit)
21 TCU
22 Display
23 Touch sensor
27 Off-board sensor
28 Camera
29 Alarm output unit
30 Traction battery (battery)
31 Charging device
40 Motor drive unit
41 Motor control unit
42 Travel motor
50 Shift device
51 Shift control unit
52 Shift operation unit
53 Transmission
60 Parking brake device
61 Parking brake control unit
62 Parking brake operation unit
63 Parking brake drive unit
110 Processor
111 Program management unit
120 Memory
121 Control program
122 Device information
123 Alternative device information
130 Processor
131 Alarm control unit
135 Memory
136 Control program
137 Setting data
D1 Update data
NW Communication network

1. A software update management device comprising:
a function of updating software of a vehicle control unit loaded on a vehicle, the function being targeted at the vehicle that comprises a travel motor as a driving source and a battery, the vehicle being configured to make transition between states including a first state where the travel motor is inoperable and a second state where the travel motor is operable, wherein
when the vehicle is in the first state and the battery is being charged, the vehicle is prohibited to make transition to the second state and the software of the vehicle control unit is updated.

2. The software update management device according to claim 1, wherein
the vehicle control unit is a device configured to control monitoring equipment that is configured to monitor the vehicle, and
a function of the monitoring equipment is stopped during update of the software of the vehicle control unit.

3. The software update management device according to claim 1, wherein the vehicle is allowed to make transition to the second state, after update of the software of the vehicle control unit is completed.

4. The software update management device according to claim 1, wherein, when charging of the battery is completed during update of the software of the vehicle control unit, the vehicle is prohibited to make transition to the second state until the update of the software of the vehicle control unit is completed.

5. The software update management device according to claim 1, wherein
the vehicle comprises a shift device configured to switch a traveling state,
the shift device is capable of switching among a plurality of shift positions including a parking state where the vehicle is parked and the traveling state where the vehicle is allowed to travel,
when the vehicle is in the first state, the battery is being charged, and the shift device is in the parking state, update of the software of the vehicle control unit is started, and
the shift device is prohibited to move from the parking state, until the update of the software of the vehicle control unit is completed.

6. The software update management device according to claim 1, wherein
the vehicle comprises a parking brake device,
when the vehicle is in the first state, the battery is being charged, and the parking brake device is in a braking state, update of the software of the vehicle control unit is started, and
release of the braking state of the parking brake device is prohibited, until the update of the software of the vehicle control unit is completed.

7. A software update management method executed by a computer that manages software of a vehicle, the vehicle comprising a travel motor as a driving source and a battery, the vehicle being configured to make transition between states including a first state where the travel motor is inoperable and a second state where the travel motor is operable, the software update management method comprising:
when the vehicle is in the first state and the battery is being charged, updating software of a vehicle control unit loaded on the vehicle while prohibiting transition of the vehicle to the second state.
